(19) United States
(12) Patent Application Publication
(10) Pub. No.: US 2026/0077952 A1
(43) Pub. Date: Mar. 19, 2026

(54) BELT TRACKING ASSEMBLY FOR A CONVEYOR SYSTEM

(71) Applicant: INTELLIGRATED HEADQUARTERS, LLC, Mason, OH (US)

(72) Inventor: Shenbaga Raman M, Charlotte, NC (US)

(21) Appl. No.: 19/314,438

(22) Filed: Aug. 29, 2025

(30) Foreign Application Priority Data
Sep. 16, 2024 (IN) 202411069902

(51) Int. Cl. B65G 15/02; B65G 39/12; B65G 39/20

(52) U.S. Cl. CPC B65G 15/02; B65G 39/12; B65G 39/20; B65G 2207/36

(57) ABSTRACT

A belt tracking assembly for a conveyor system is disclosed. The belt tracking assembly comprises a sheave defining a groove. Further, the belt tracking assembly comprises an idler roller. Furthermore, the belt tracking assembly comprises a belt positioned between the sheave and the idler roller, the belt having a loop shape and comprising a first surface that has a protrusion and a second surface that is flat. The first surface is opposite to the second surface. The protrusion of the first surface of the belt is positioned within the groove of the sheave. The second surface of the belt is positioned on the idler roller.

### CROSS-REFERENCE TO RELATED APPLICATION

This application claims priority pursuant to 35 U.S. C. 119(a) to Indian Patent Application No. 202411069902, filed Sep. 16, 2024, which application is incorporated herein by reference in its entirety.

### TECHNOLOGICAL FIELD

Example embodiments of the present disclosure generally relates to conveyor systems, and more particularly, to a belt tracking assembly for a conveyor system.

### BACKGROUND

Within the conventional zone control conveyors, a noticeable absence persists in the form of pneumatic actuated belt curved sections, creating a notable gap in functionality of the zone control conveyors. The task of devising the pneumatic actuated belt curved sections poses formidable challenges, particularly relating to obstacles in maintaining proper belt alignment. Moreover, traditional methods reliant on straight sections for belt tracking and tensioning prove inadequate when confronted with the necessity for curved motion. The utilization of the existing chain-operated system in curved sections is affected by excessive noise levels, demanding maintenance requirements, and the substantial cost associated with constant zone control operation. Furthermore, existing systems, while advanced, face significant hurdles in operating efficiently within curved sections, primarily stemming from persistent belt tracking and tensioning issues.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### SUMMARY

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In an example embodiment, a belt tracking assembly for a conveyor system is disclosed. The belt tracking assembly comprises a sheave defining a groove. Further, the belt tracking assembly comprises an idler roller. Furthermore, the belt tracking assembly comprises a belt positioned between the sheave and the idler roller, the belt having a loop shape and comprising a first surface that has a protrusion and a second surface that is flat. The first surface is opposite to the second surface. The protrusion of the first surface of the belt is positioned within the groove of the sheave. The second surface of the belt is positioned on the idler roller.

In some embodiments, the belt tracking assembly further comprising a pair of side rails, wherein at least one of the pair of side rails is coupled to the sheave via a shoulder bolt. In some embodiments, the belt tracking assembly further comprising a plurality of tapered rollers arranged between the pair of side rails. The sheave and the idler roller are positioned above the plurality of tapered rollers.

In some embodiments, the belt tracking assembly further comprising a pressure shoe assembly mounted underneath the plurality of tapered rollers. The pressure shoe assembly comprises one or more rollers, one or more pressure shoes, and one or more diaphragms.

In some embodiments, the belt comprises a top slack side and a bottom tight side. In some embodiments, the top slack side of the belt is positioned between the sheave and the idler roller, and the bottom tight side is positioned between the plurality of tapered rollers and the one or more rollers. In some embodiments, each of the one or more diaphragms is configured to actuate to position the pressure shoe assembly from a first position to a second position.

In some embodiments, in the first position of the pressure shoe assembly, the belt positioned between the plurality of tapered rollers and the one or more rollers is not in contact with the plurality of tapered rollers. In some embodiments, in the second position of the pressure shoe assembly, the belt positioned between the plurality of tapered rollers and the one or more rollers is in contact with the plurality of tapered rollers.

In some embodiments, the belt is configured to transfer a rotational movement to the plurality of tapered rollers, in an instance when the one or more rollers comes in contact with the plurality of tapered rollers.

In another example embodiment, a method is disclosed. The method comprises the steps of positioning a belt between a sheave and an idler roller, wherein the belt has a loop shape and comprises a first surface that has a protrusion and a second surface that is flat. The first surface is opposite to the second surface. The protrusion of the first surface of the belt is positioned within a groove of the sheave. The second surface of the belt is positioned on the idler roller.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a perspective view of a conveyor system in accordance with an example embodiment of the present disclosure;

FIG. 2 illustrates a top view of the conveyor system in accordance with an example embodiment of the present disclosure;

FIG. 3A illustrates a bottom view of the conveyor system in accordance with an example embodiment of the present disclosure;

FIG. 3B illustrates a perspective view of a pressure shoe assembly of a belt tracking assembly of a curve section of the conveyor system in accordance with an example embodiment of the present disclosure;

FIG. 4A illustrates a cross-sectional view of the belt tracking assembly in accordance with an example embodiment of the present disclosure;

FIG. 4B-4C illustrate perspective views of the pressure shoe assembly of the belt tracking assembly in accordance with an example embodiment of the present disclosure;

FIG. 5A illustrates a perspective view of a sheave and an idler roller of the belt tracking assembly in accordance with an example embodiment of the present disclosure;

FIG. 5B illustrates a side view of the sheave and the idler roller of the belt tracking assembly in accordance with an example embodiment of the present disclosure;

FIG. 5C illustrates a cross-sectional view of the sheave of the belt tracking assembly in accordance with an example embodiment of the present disclosure;

FIG. 6A-6C illustrate perspective views of at least one belt tensioner of the conveyor system in accordance with an example embodiment of the present disclosure;

FIG. 7A illustrates a perspective view of a belt of the belt tracking assembly in accordance with an example embodiment of the present disclosure;

FIG. 7B illustrates a perspective view of a pulley of the conveyor system in accordance with an example embodiment of the present disclosure; and,

FIG. 8 illustrates an exemplary scenario of a conveyor line of the conveyor system carrying one or more objects using the belt tracking assembly in accordance with an example embodiment of the present disclosure.

### DETAILED DESCRIPTION OF THE INVENTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the invention described herein such that embodiments may include fewer or more components than those shown in the figures while not departing from the scope of the invention. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration. ” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of a belt tracking assembly for a conveyor system. In various embodiments, the belt tracking assembly may be installed at a curve section of the conveyor system. Embodiments may comprise a a sheave defining a groove, and an idler roller. Embodiments may comprise a belt positioned between the sheave and the idler roller, the belt having a loop shape and comprising a first surface that has a protrusion and a second surface that is flat. In various embodiments, the first surface may be opposite to the second surface. In various embodiments, the protrusion of the first surface of the belt may be positioned within the groove of the sheave. In various embodiments, the second surface of the belt may be positioned on the idler roller.

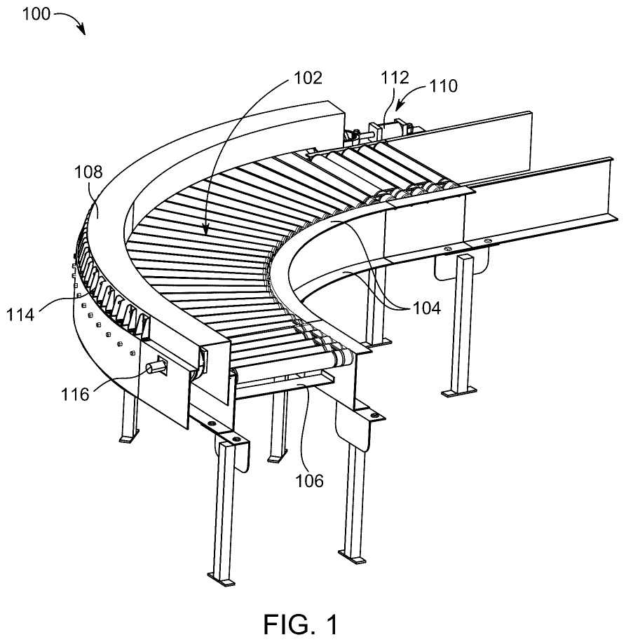

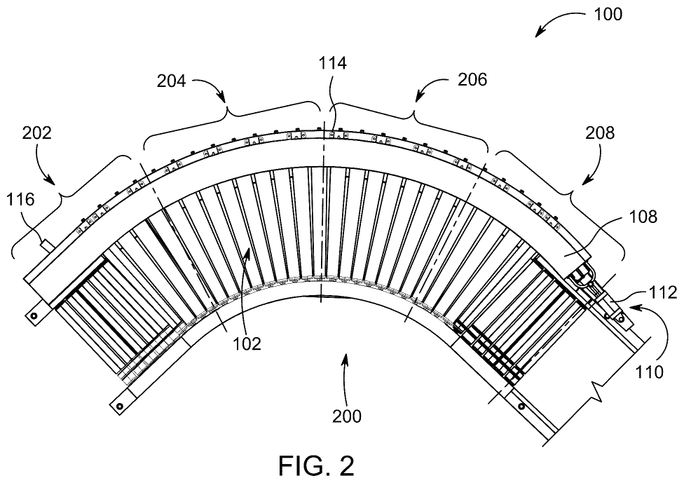

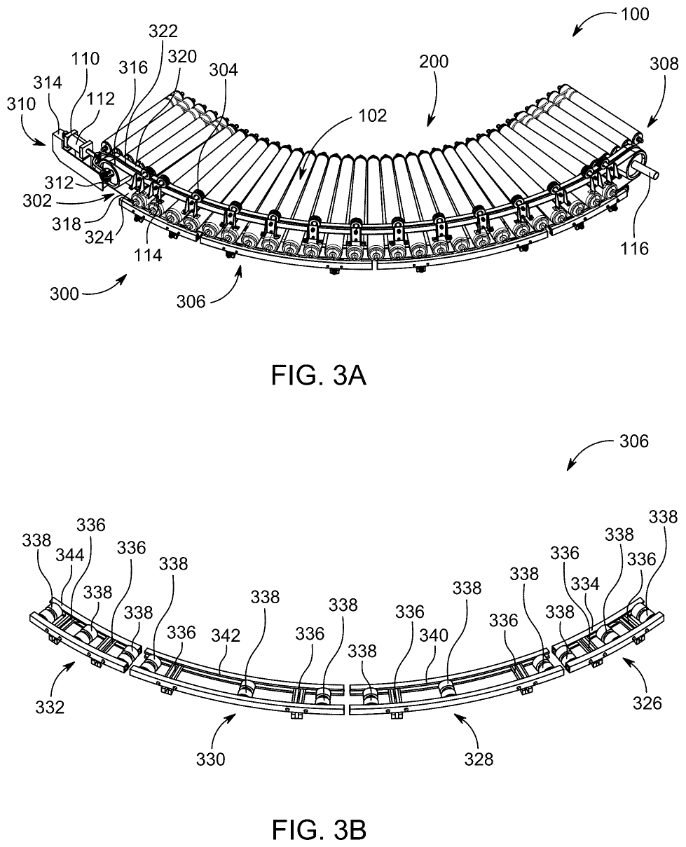

FIG. 1 illustrates a perspective view of a conveyor system 100, in accordance with an example embodiment of the present disclosure. FIG. 2 illustrates a top view of the conveyor system 100, in accordance with an example embodiment of the present disclosure. FIG. 3A illustrates a bottom view of the conveyor system 100 in accordance with an example embodiment of the present disclosure. FIG. 3B illustrates a perspective view of a pressure shoe assembly 306 of a belt tracking assembly 300 of a curve section 200 of the conveyor system 100, in accordance with an example embodiment of the present disclosure.

In some embodiments, the conveyor system 100 may comprise a plurality of tapered rollers 102, a pair of side rails 104, a spreader 106, and a cover 108. The conveyor system 100 may comprise at least one belt tensioner 110. In some embodiments, the at least one belt tensioner 110 may have a belt tensioning cylinder 112. Further, the conveyor system 100 may comprise a first mounting bracket 114 and an input shaft 116. The plurality of tapered rollers 102 may be arranged between the pair of side rails 104. The plurality of tapered rollers 102 may aid in smoothly guiding and moving one or more objects along the conveyor system 100 in the curve section 200. In some embodiments, the plurality of tapered rollers 102 are a type of rolling elements which are designed to handle both radial and axial loads. The plurality of tapered rollers 102 may be shaped like truncated cones, with a large end of the cone being wider (e.g., has a greater diameter) than a small end of the cone. The plurality of tapered rollers 102 enables to efficiently support combined loads and reduces friction in rotating applications.

In some embodiments, the pair of side rails 104 of the conveyor system 100 are structural components used to guide, contain, and protect the one or more objects as they are transported along a conveyor system 100. In some embodiments, the pair of side rails 104 may serve as boundaries to keep the one or more objects on track and prevent the one or more objects from falling off the plurality of tapered rollers 102. The pair of side rails 104 may be configured to be installed on either sides of the conveyor system 100 to ensure that the one or more objects stay on the and do not fall off or get misaligned from the plurality of tapered rollers 102. Further, the spreader 106 may be utilized to ensure even distribution of the one or more objects across width of the conveyor system 100.

In some embodiments, the cover 108 may protect the conveyor system 100 and the components of the conveyor system 100 from external factors such as dust or debris. The at least one belt tensioner 110 may be configured to maintain proper tension in a belt 302 (FIG. 3A), using the belt tensioning cylinder 112 of the conveyor system 100 to ensure efficient and reliable operation. In one example embodiment, the conveyor system 100 may correspond to an upstream/downstream conveyor. Further, the first mounting bracket 114 may be configured to mount the cover 108 on the conveyor system 100. In some embodiments, one end of the plurality of tapered rollers 102 may be installed with the input shaft 116. In some embodiments, the input shaft 116 is configured to transmit power from a drive source to the plurality of tapered rollers 102. In some embodiments, the drive source may correspond to at least one of a motor or an engine. In some embodiments, the input shaft 116 may be configured to drive the belt 302 of the conveyor system 100, in one or more directions.

In some embodiments, the conveyor system 100 may comprise the curve section 200, as illustrated in FIGS. 1-3. The curve section 200 of the conveyor system 100 may be segregated into a plurality of zones, as depicted in FIG. 2. In one example, the plurality of zones may comprise a first zone, as illustrated by 202. In another example, the plurality of zones may comprise a second zone, as illustrated by 204. In yet another example, the plurality of zones may comprise a third zone, as illustrated by 206. In another example, the plurality of zones may comprise a fourth zone, as illustrated by 208. The one or more zones of the plurality of zones may be selectively energized for carrying one or more objects from the plurality of tapered rollers 102.

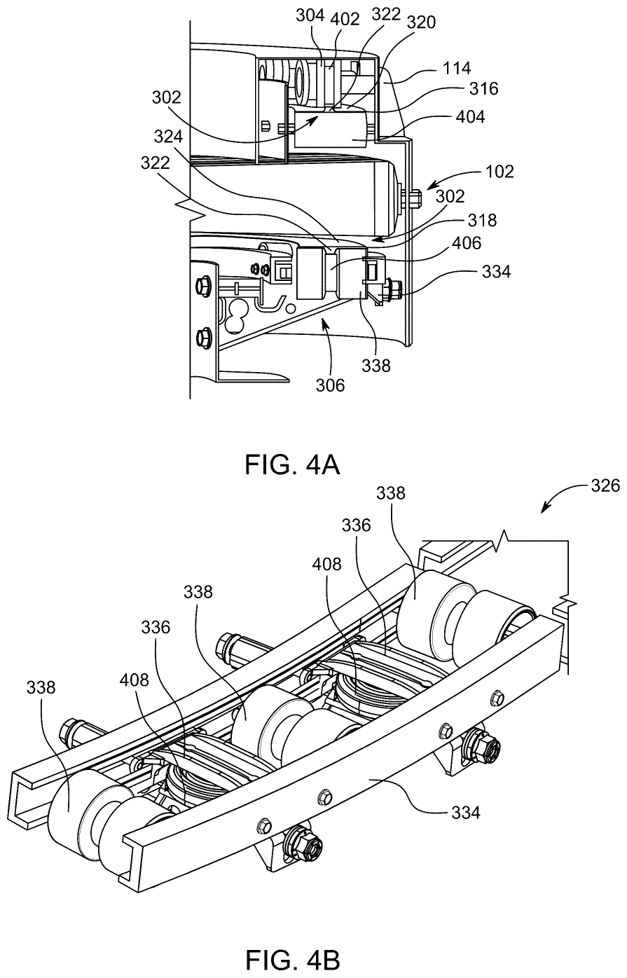

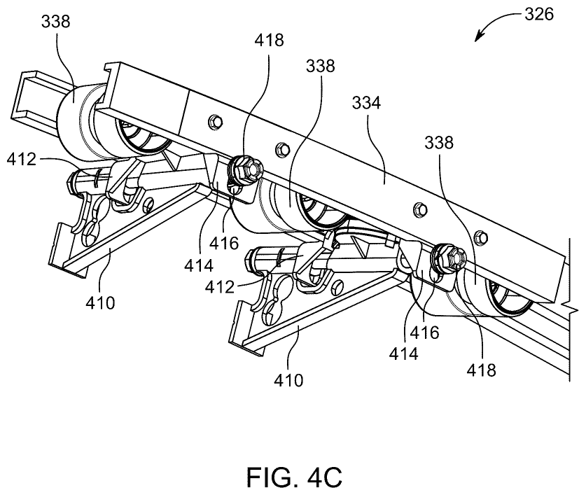

In some embodiments, the curve section 200 may comprise a belt tracking assembly 300, as illustrated in FIG. 3A. The belt tracking assembly 300 may be installed at the curve section 200 of the conveyor system 100. The belt tracking assembly 300 may comprise the plurality of tapered rollers 102, the belt 302 having a loop shape, a sheave 304 defining a groove 402 (FIG. 4A), a pressure shoe assembly 306, as illustrated in FIG. 3A. In some embodiments, the pressure shoe assembly 306 may be assigned for each zone of the plurality of zones. Further, the pressure shoe assembly 306 may have a different configuration for each zone, as described later in detail in the detailed description.

In some embodiments, the plurality of tapered rollers 102 may collectively define a first end, as illustrated by 308. Further, the plurality of tapered rollers 102 may collectively define a second end, as illustrated by 310. Further, the input shaft 116 may be positioned at the first end of the plurality of tapered rollers 102. The input shaft 116 may correspond to a drive shaft. Further, a pulley 312 may be positioned at the second end of the plurality of tapered rollers 102. The pulley 312 may correspond to a driven shaft. The input shaft 116, when actuated, may be configured to drive the belt 302 along with the pulley 312 in the one or more directions. In some embodiments, the one or more directions may correspond to either a forward direction or a backward direction. Further, the at least one belt tensioner 110 may be positioned on the second end of the plurality of tapered rollers 102. The at least one belt tensioner 110 may comprise the belt tensioning cylinder 112 mounted over a second mounting bracket 314. The belt tensioning cylinder 112 may be configured to expand or retract to pull or push the pulley 312 to alter tension over the belt 302. In some embodiments, the sheave 304 may be positioned along at least one of the pair of side rails 104. Further, the sheave 304 may be positioned above the plurality of tapered rollers 102. The sheave 304 may be attached to the pair of side rails 104 via the first mounting bracket 114.

In some embodiments, the pressure shoe assembly 306 may be mounted underneath the plurality of tapered rollers 102. The pressure shoe assembly 306 may comprise a frame, one or more rollers 338, one or more pressure shoes 336, and one or more diaphragms 408 (FIG. 4B). In one example embodiments, the belt tracking assembly 300 comprises a plurality of pressure shoe assemblies 306. For example, the belt tracking assembly 300 may comprise a first pressure shoe assembly 326, a second pressure shoe assembly 328, a third pressure shoe assembly 330, and/or a fourth pressure shoe assembly 332, as illustrated in FIG. 3B, based at least on each zone of the plurality zones. In one example, the first pressure shoe assembly 326 may comprise a first frame 334, at least two pressure shoes 336 of the one or more pressure shoes 336, and at least three rollers 338 from the one or more rollers 338. In another example, the second pressure shoe assembly 328 may comprise a second frame 340, the at least two pressure shoes 336, and the at least three rollers 338. In yet another example, the third pressure shoe assembly 330 may comprise a third frame 342, the at least two pressure shoes 336, and the at least three rollers 338. In another example, the fourth pressure shoe assembly 332 may comprise a fourth frame 344, the at least two pressure shoes 336, and the at least three rollers 338. In some embodiments, a distance among the at least two pressure shoes 336 and the at least three rollers 338 may change based at least on the first frame 334, the second frame 340, the third frame 342, or the fourth frame 344. The first pressure shoe assembly 326, the second pressure shoe assembly 328, the third pressure shoe assembly 330, and the fourth pressure shoe assembly 332 may be individually configured to move between a first position and a second position.

In some embodiments, the belt 302 may comprise a top slack side 316 and a bottom tight side 318. In some embodiments, the belt 302 may comprise a top tight side and a bottom slack side. The belt 302 may be configured to rotate around the plurality of tapered rollers 102. The top slack side 316 and the bottom tight side 318 may comprise a first surface 320 that has a protrusion 322 and a second surface 324 that is flat. In some embodiments, the first surface 320 of the top slack side 316 having the protrusion 322 may correspond to the first surface 320 of the bottom tight side 318. In some embodiments, the second surface 324 of the bottom tight side 318 may correspond to the second surface 324 of the top slack side 316. Further, the first surface 320 may be opposite to the second surface 324. The protrusion 322 of the first surface 320 of the belt 302 may be positioned within the groove 402 of the sheave 304. The first surface 320 of the top slack side 316 of the belt 302 may fit into the sheave 304. The bottom tight side 318 of the belt 302 may be positioned between the plurality of tapered rollers 102 and the one or more rollers 338.

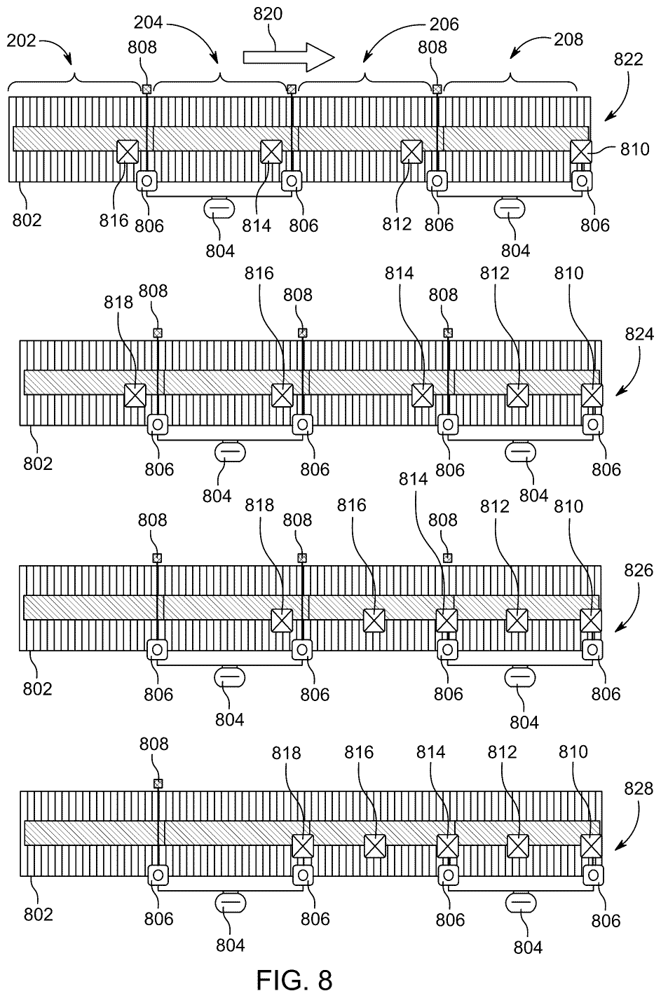

As depicted in FIG. 2, the curve section 200 of the conveyor system 100 may be segregated into the plurality of zones. The first zone may comprise the first pressure shoe assembly 326. The second zone may comprise the second pressure shoe assembly 328. The third zone may comprise the third pressure shoe assembly 330. The fourth zone may comprise the fourth pressure shoe assembly 332. In some embodiments, the conveyor system 100 may further comprise at least one controller 804 (FIG. 8). The at least one controller 804 may be configured to generate at least one command to selectively actuate the pressure shoe assembly 306. The pressure shoe assembly 306 may be actuated to selectively energize the one or more zones of the plurality of zones for carrying one or more objects from the plurality of tapered rollers 102. In one example, the at least one controller 804 may be configured to generate at least one command to selectively actuate the first pressure shoe assembly 326, the second pressure shoe assembly 328, the third pressure shoe assembly 330, and/or the fourth pressure shoe assembly 332 to selectively energize the first zone, the second zone, the third zone and/or the fourth zone, respectively, for carrying the one or more objects from the plurality of tapered rollers 102, as described in greater detail in conjunction with FIG. 8 in the detailed description.

Further, the at least one controller 804 may further comprise a processor and a memory. In some embodiments, the processor may include suitable logic, circuitry, and/or interfaces that are operable to execute one or more instructions stored in the memory to perform predetermined operations. In one embodiment, the processor may be configured to decode and execute any instructions received from one or more other electronic devices or server(s). The processor may be configured to execute one or more computer-readable program instructions, such as program instructions to carry out any of the functions described in this description. Further, the processor may be implemented using one or more processor technologies known in the art. Examples of the processor include, but are not limited to, one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor).

Further, the memory may store a set of instructions and data. Further, the memory may include one or more instructions that are executable by the processor to perform specific operations. It is apparent to a person with ordinary skill in the art that the one or more instructions stored in memory enable the hardware of the system to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

FIG. 4A illustrates a cross-sectional view of the belt tracking assembly 300, in accordance with an example embodiment of the present disclosure. FIGS. 4B-4C illustrate perspective views of the pressure shoe assembly 306 of the belt tracking assembly 300, in accordance with an example embodiment of the present disclosure. FIGS. 4A-4C are described in conjunction with FIGS. 1-3B.

As depicted in FIG. 3A, the sheave 304 may be positioned along the at least one side rail of the pair of side rails 104. And the sheave 304 may be positioned above the plurality of tapered rollers 102. The sheave 304 may be attached to the pair of side rails 104 via the first mounting bracket 114. The sheave 304 may comprise the groove 402. In some embodiments, the belt tracking assembly 300 may further comprise an idler roller 404. The idler roller 404 may be positioned along the at least one of the pair of side rails 104 and positioned underneath the sheave 304. The idler roller 404 may be positioned above the plurality of tapered rollers 102. Further, the belt 302 may be positioned between the sheave 304 and the idler roller 404. The second surface 324 of the belt 302 may be positioned on the idler roller 404. The top slack side 316 of the belt 302 may be positioned between the sheave 304 and the idler roller 404, and the bottom tight side 318 of the belt 302 may be positioned between the one or more rollers 338 and the plurality of tapered rollers 102.

Further, the pressure shoe assembly 306 may be mounted underneath the plurality of tapered rollers 102. The pressure shoe assembly 306 may comprise the one or more rollers 338, the one or more diaphragms 408. The one or more rollers 338 may comprise a V-shaped groove 406. Further, each of the one or more diaphragms 408 may be positioned underneath each of the one or more pressure shoes 336 along the first frame 334. Further, each of the one or more diaphragms 408 may be configured to actuate to position the pressure shoe assembly 306 from the first position to the second position. In some embodiments, the one or more diaphragms 408 may actuate to push the one or more pressure shoes 336 that in turn lifts the pressure shoe assembly 306 from the first position to the second position. The pressure shoe assembly 306 may be lifted from the first position to the second position to allow the one or more rollers 338 to engage with the first surface of the belt 302. Further, the belt 302 may be pushed to grip the plurality of tapered rollers 102 to rotate the plurality of tapered rollers 102 in one or more directions. In the first position of the pressure shoe assembly 306, the belt 302 positioned between the plurality of tapered rollers 102 and the one or more rollers 338 may not be in contact with the plurality of tapered rollers 102. In the second position of the pressure shoe assembly 306, the belt 302 positioned between the plurality of tapered rollers 102 and the one or more rollers 338 may be in contact with the plurality of tapered rollers 102. The belt 302 may be configured to transfer a rotational movement to the plurality of tapered rollers 102, in an instance when the one or more rollers 338 comes in contact with the plurality of tapered rollers 102.

In some embodiments, the pressure shoe assembly 306 may comprise a diaphragm holder 410, as illustrated in FIG. 4C. The diaphragm holder 410 may be mounted with the at least one side rail of the pair of side rails 104. In one example embodiment, the pressure shoe assembly 306 may comprise the diaphragm holder 410 mounted with the at least one side rail. The diaphragm holder 410 may comprise a first portion 412 and a second portion 414. The first portion 412 of the diaphragm holder 410 may be configured to hold the one or more diaphragms 408. The second portion 414 may comprise at least one slot 416, as illustrated in FIG. 4C. The at least one slot 416 may be coupled with the pressure shoe assembly 306. In some embodiments, the at least one slot 416 may be configured to provide guided movement to the pressure shoe assembly 306 in vertical direction. In some embodiments, a nut 418 may be fitted in the at least one slot 416. The nut 418 may be attached to the first frame 334 and moves inside the at least one slot 416 as the pressure shoe assembly 306 moves from the first position to the second position. Further, the at least one slot 416 may provide a maximum travel limit to the first frame 334 such that the first frame 334 only moves in vertical up and down direction, i.e., the first position and the second position, during the actuation of the one or more diaphragms 408.

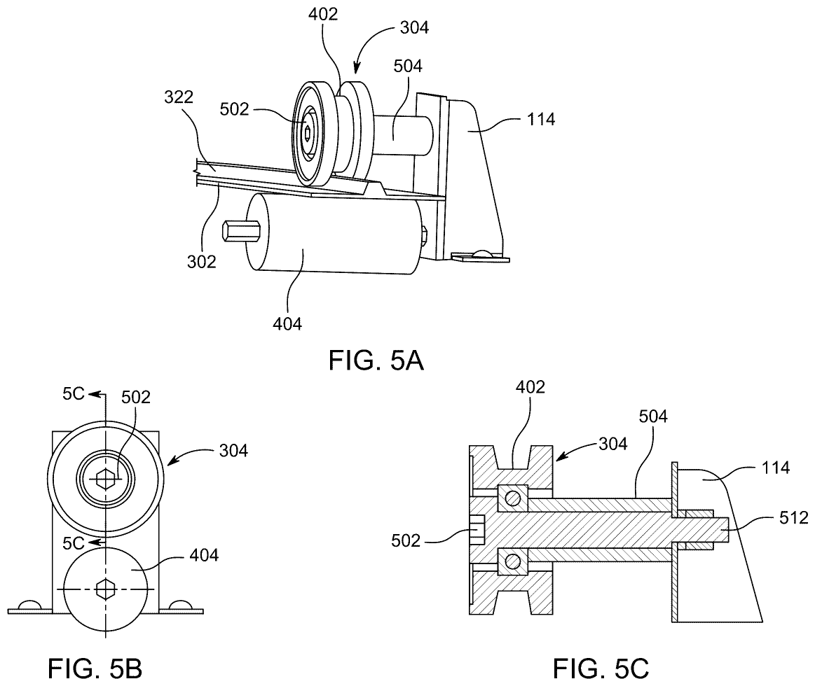

FIG. 5A illustrates a perspective view of the sheave 304 and the idler roller 404 of the belt tracking assembly 300, in accordance with an example embodiment of the present disclosure. FIG. 5B illustrates a side view of the sheave 304 and the idler roller 404 of the belt tracking assembly 300, in accordance with an example embodiment of the present disclosure. FIG. 5C illustrates a cross-sectional view of the sheave 304 of the belt tracking assembly 300, in accordance with an example embodiment of the present disclosure. FIGS. 5A-5C are described in conjunction with FIGS. 3A-4C.

As depicted in FIG. 3A, the sheave 304 may be attached to the pair of side rails 104 via the first mounting bracket 114. In some embodiments, the sheave 304 may comprise a shoulder bolt 502 and a spacer 504, as illustrated in 5A. The at least one of the pair of side rails 104 may be coupled to the sheave 304 via the shoulder bolt 502. The shoulder bolt 502 may be configured to fasten the sheave 304 with the spacer 504 that is further coupled to the first mounting bracket 114. In some embodiments, the sheave 304 may define the groove 402. In one example, the groove 402 may be a V shaped groove. For example, the groove 402 may have a cross-sectional shape that is a truncated triangle. The groove 402 may be configured to allow the protrusion 322 of the first surface of the belt 302 to fit within the groove 402.

In some embodiments, the first surface of the belt 302 may be configured to have the protrusion 322. In one example, the protrusion 322 may correspond to a V shape guide. For example, the protrusion 322 may have a cross-sectional shape that is a truncated triangle. The protrusion 322 of the belt 302 at the top slack side 316 of the belt 302 may be configured to fit inside the groove 402 of the sheave 304. The belt 302 may be fit in between the idler roller 404 and the sheave 304. As depicted in FIG. 4A, the one or more rollers 338 may comprise the V-shaped groove 406. The V-shaped groove 406 may be further configured to track the first surface of the belt 302 having the protrusion 322 at the bottom tight side 318 of the belt 302. Further, the spacer 504 may be configured to couple with the first mounting bracket 114 via a nut 512, as illustrated in FIG. 5C.

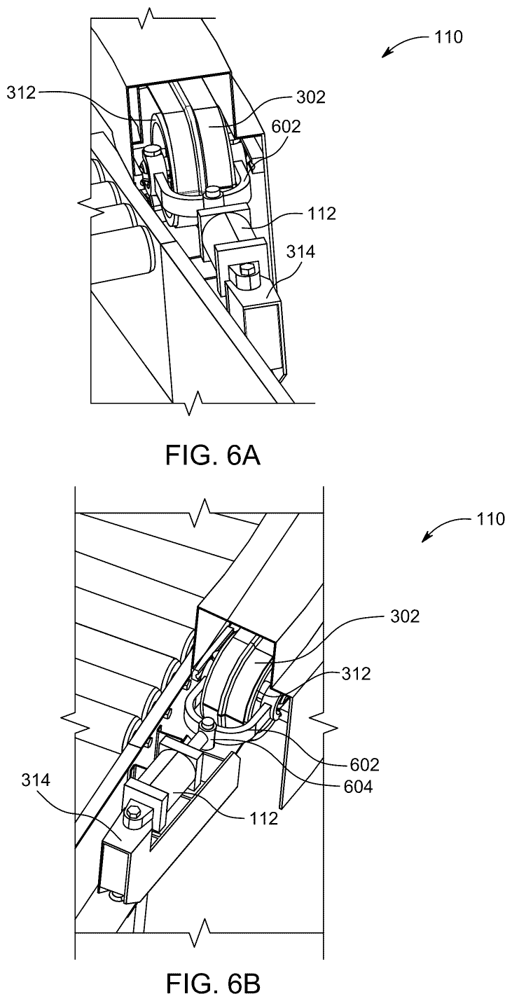

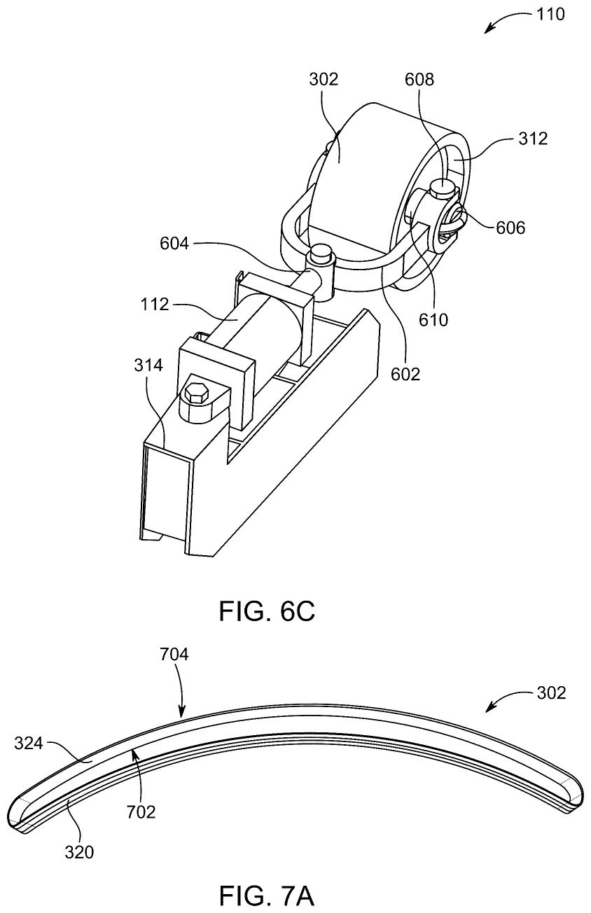

FIGS. 6A-6C illustrate perspective views of at least one belt tensioner 110 of the conveyor system 100, in accordance with an example embodiment of the present disclosure. FIGS. 6A-6C are described in conjunction with FIGS. 1-5C.

As depicted in FIG. 3A, the at least one belt tensioner 110 may be positioned on the second end of the plurality of tapered rollers 102. The at least one belt tensioner 110 may comprise the belt tensioning cylinder 112. In one example, the belt tensioning cylinder 112 may correspond to a pneumatic cylinder. The belt tensioning cylinder 112 may be mounted over the second mounting bracket 314. Further, the belt tensioning cylinder 112 may comprise a connecting lever 602, as illustrated in FIG. 6A. The connecting lever 602 may be configured to couple the pulley 312 with the belt tensioning cylinder 112. Further, the pulley 312 may be coupled with the belt tensioning cylinder 112 via a pivot joint 604, as illustrated in FIG. 6B. The belt tensioning cylinder 112 may be configured to expand or retract to pull or push the pulley 312 to alter tension over the belt 302.

In some embodiments, the connecting lever 602 may be coupled with the pulley 312 via a roller 606, a pin 608, and a shaft 610, as illustrated in FIG. 6C. The roller 606 may be affixed to the connecting lever 602 via the pin 608 to ensure smooth motion transmission by reducing friction against the surface of the pulley 312, as the pulley 312 rotates. The pin 608 may securely attach the roller 606 to the connecting lever 602 to prevent slippage, as the belt 302 rotates. Further, the shaft 610 may provide support and stability, by passing through a center of the pulley 312. The roller 606, the pin 608, and the shaft 610 may enable synchronized motion between the connecting lever 602 and the pulley 312 to facilitate the transfer of power or the transfer of the rotational movement to the plurality of tapered rollers 102.

It will be apparent to one skilled in the art that the above-mentioned components of the belt tracking assembly 300 have been provided only for illustration purposes, without departing from the scope of the disclosure.

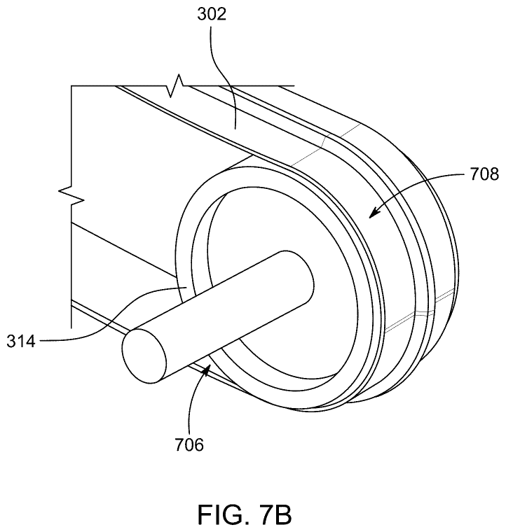

FIG. 7A illustrates a perspective view of the belt 302 of the belt tracking assembly 300, in accordance with an example embodiment of the present disclosure. FIG. 7B illustrates a perspective view of the pulley 312 of the conveyor system, in accordance with an example embodiment of the present disclosure. FIGS. 7A-7B are described in conjunction with FIGS. 1-6C.

In some embodiments, the second surface 324 of the belt 302 may define an inner radius Rᵢ, as illustrated by 702 in FIG. 7A. Further, the first surface 320 of the belt 302 may define an outer radius Rₒ, as illustrated by 704 in FIG. 7A. The belt 302 may define an overall radius r. The r may be equal to ratio of the Rₒ and the Rᵢ. In one example embodiment, the r may define a belt profile of the belt 302. In some embodiments, the second surface 324 of the belt 302 may define an arc length Aᵢ at the inner radius Rᵢ, as illustrated by 706 in FIG. 7B. Further, the first surface 320 of the belt 302 may define an arc length Aₒ outer radius Rₒ, as illustrated by 708 in FIG. 7B. In some embodiments, the Aₒ may be equal to a product of the r and the Aᵢ. The product may correspond to a relation between the dimensions of the pulley 312 and the r of the belt 302.

FIG. 8 illustrates an exemplary scenario of a conveyor line 802 of the conveyor system 100 carrying the one or more objects using the belt tracking assembly 300, in accordance with an example embodiment of the present disclosure. FIG. 8 is described in conjunction with FIGS. 1-6C.

As depicted in FIG. 3A, at least one controller 804 may be configured to generate at least one command to selectively actuate the pressure shoe assembly 306. In some embodiments, the at least one controller 804 may be operationally coupled with at least one photo-eye 806. The at least one photo-eye 806 may detect the presence or absence of the one or more objects within a field of view of the at least one photo-eye 806. In one example embodiment, the at least one photo-eye 806 may correspond to an unblocked photo-eye 808 in an instance in which a beam emitted by the at least one photo-eye is not obstructed and may freely travel from an emitter to a receiver without encountering any obstacles. The detected presence or absence may be then utilized by the at least one controller 804 to generate the at least one command for selectively actuating the pressure shoe assembly 306, as required. The pressure shoe assembly 306 may be actuated to selectively energize each zone of the plurality of zones for carrying the one or more objects over the plurality of tapered rollers 102 on the conveyor line 802. The one or more objects may comprise a first object 810, a second object 812, a third object 814, a fourth object 816, and a fifth object 818.

In some embodiments, the conveyor line 802 may move in a forward direction, as illustrated by an arrow 820, to carry the one or more objects using the belt tracking assembly 300. In one example, the at least one controller 804 may be configured to generate the at least one command to selectively actuate the first pressure shoe assembly 326, the second pressure shoe assembly 328, and the third pressure shoe assembly 330 to selectively energize the first zone, the second zone, and the third zone for carrying the second object 812, the third object 814, the fourth object 816 over the plurality of tapered rollers 102 in the conveyor line 802, as illustrated by 822.

In another example, the at least one controller 804 may be configured to generate that at least one command to selectively actuate the first pressure shoe assembly 326 and the second pressure shoe assembly 328 to selectively energize the first zone and the second zone for carrying the fourth object 816, and the fifth object 818 over the plurality of tapered rollers 102 in the conveyor line 802, as illustrated by 824. In yet another example, the at least one controller 804 may be configured to generate at least one command to selectively actuate the first pressure shoe assembly 326 to selectively energize the first zone for carrying the fifth object 818 over the plurality of tapered rollers 102 in the conveyor line 802, as illustrated by 826. In another example, the at least one controller 804 may be configured to generate that at least one command to selectively actuate the first pressure shoe assembly 326, the second pressure shoe assembly 328, the third pressure shoe assembly 330, and the fourth pressure shoe assembly 332 to selectively energize the first zone, the second zone, the third zone, and the fourth zone to further carry the one or more objects over the conveyor line 802 to a respective conveyor line, as illustrated by 828.

In an exemplary embodiment, a method is disclosed. At first operation, the belt 302 may be positioned between the between the sheave 304 and the idler roller 404, wherein the belt 302 has the loop shape and comprises the first surface that has the protrusion 322 and the second surface that is flat. The first surface may be opposite to the second surface. The protrusion 322 of the first surface of the belt 302 may be positioned within the groove 402 of the sheave 304. The second surface of the belt 302 may be positioned on the idler roller 404. In some embodiments, the belt 302 may comprise the top slack side 316 and the bottom tight side 318. The top slack side 316 of the belt 302 may be positioned between the sheave 304 and the idler roller 404. The bottom tight side 318 may be positioned between the plurality of tapered rollers 102 and the one or more rollers 338.

In some embodiments, the method may further comprise coupling at least one of the pair of side rails 104 to the sheave 304 via the shoulder bolt 502. Further, the method may comprise arranging the plurality of tapered rollers 102 between the pair of side rails 104. The sheave 304 and the idler roller 404 may be positioned above the plurality of tapered rollers 102. Furthermore, the method may comprise mounting the pressure shoe assembly 306 underneath the plurality of tapered rollers 102. The pressure shoe assembly 306 may comprise the one or more rollers 338, the one or more pressure shoes 336, and the one or more diaphragms 408. The method may further comprise actuating each of the one or more diaphragms 408 to position the pressure shoe assembly 306 from the first position to the second position.

In some embodiments, in the first position of the pressure shoe assembly 306, the belt 302 may be positioned between the plurality of tapered rollers 102 and the one or more rollers 338 may not be in contact with the plurality of tapered rollers 102. In some embodiments, in the second position of the pressure shoe assembly 306, the belt 302 may be positioned between the plurality of tapered rollers 102 and the one or more rollers 338 may come in contact with the plurality of tapered rollers 102. The method may further comprise transferring, via the belt 302, the rotational movement to the plurality of tapered rollers 102, in an instance when the one or more rollers 338 comes in contact with the plurality of tapered rollers 102.

The present invention provides various embodiments of the belt tracking assembly designed for curve sections of conveyor systems with enhanced stability due to the secure fit of the belt's protrusion within the sheave's groove, which minimizes misalignment and slippage. The present invention may improve durability, as the increased friction helps extend the lifespan of both the belt and the system. Additionally, the loop shape of the belt may facilitate continuous operation, leading to smoother material transport without frequent adjustments. In the present invention, maintenance requirements are reduced due to the effective tracking, which lowers operational downtime and associated costs. Furthermore, the belt tracking assembly's versatility may allow the belt tracking assembly to be adapted to various conveyor designs and applications, making the present invention suitable for a wide range of industries.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A belt tracking assembly for a conveyor system, the belt tracking assembly comprising:
a sheave defining a groove;
an idler roller; and,
a belt positioned between the sheave and the idler roller, the belt having a loop shape and comprising a first surface that has a protrusion and a second surface that is flat, wherein:
the first surface is opposite to the second surface;
the protrusion of the first surface of the belt is positioned within the groove of the sheave; and,
the second surface of the belt is positioned on the idler roller.

2. The belt tracking assembly of claim 1, further comprising a pair of side rails, wherein at least one of the pair of side rails is coupled to the sheave via a shoulder bolt.

3. The belt tracking assembly of claim 2, further comprising a plurality of tapered rollers arranged between the pair of side rails, wherein the sheave and the idler roller are positioned above the plurality of tapered rollers.

4. The belt tracking assembly of claim 3, further comprising a pressure shoe assembly mounted underneath the plurality of tapered rollers, wherein the pressure shoe assembly comprises one or more rollers, one or more pressure shoes, and one or more diaphragms.

5. The belt tracking assembly of claim 4, wherein the belt comprises a top slack side and a bottom tight side.

6. The belt tracking assembly of claim 5, wherein the top slack side of the belt is positioned between the sheave and the idler roller, and the bottom tight side is positioned between the plurality of tapered rollers and the one or more rollers.

7. The belt tracking assembly of claim 4, wherein each of the one or more diaphragms is configured to actuate to position the pressure shoe assembly from a first position to a second position.

8. The belt tracking assembly of claim 7, wherein in the first position of the pressure shoe assembly, the belt is positioned between the plurality of tapered rollers and the one or more rollers is not in contact with the plurality of tapered rollers.

9. The belt tracking assembly of claim 7, wherein in the second position of the pressure shoe assembly, the belt is positioned between the plurality of tapered rollers and the one or more rollers is in contact with the plurality of tapered rollers.

10. The belt tracking assembly of claim 9, wherein the belt is configured to transfer a rotational movement to the plurality of tapered rollers, in an instance when the one or more rollers comes in contact with the plurality of tapered rollers.

11. A method comprising:
positioning a belt between a sheave and an idler roller, wherein the belt has a loop shape and comprises a first surface that has a protrusion and a second surface that is flat, wherein:
the first surface is opposite to the second surface;
the protrusion of the first surface of the belt is positioned within a groove of the sheave; and,
the second surface of the belt is positioned on the idler roller.

12. The method of claim 11, further comprising coupling at least one of a pair of side rails to the sheave via a shoulder bolt.

13. The method of claim 12, further comprising arranging a plurality of tapered rollers between the pair of side rails, wherein the sheave and the idler roller are positioned above the plurality of tapered rollers.

14. The method of claim 13, further comprising mounting a pressure shoe assembly underneath the plurality of tapered rollers, wherein the pressure shoe assembly comprises one or more rollers, one or more pressure shoes, and one or more diaphragms.

15. The method of claim 14, wherein the belt comprises a top slack side and a bottom tight side.

16. The method of claim 15, wherein the top slack side of the belt is positioned between the sheave and the idler roller, and the bottom tight side is positioned between the plurality of tapered rollers and the one or more rollers.

17. The method of claim 14, further comprising actuating each of the one or more diaphragms to position the pressure shoe assembly from a first position to a second position.

18. The method of claim 17, wherein in the first position of the pressure shoe assembly, the belt is positioned between the plurality of tapered rollers and the one or more rollers is not in contact with the plurality of tapered rollers.

19. The method of claim 17, wherein in the second position of the pressure shoe assembly, the belt is positioned between the plurality of tapered rollers and the one or more rollers comes in contact with the plurality of tapered rollers.

20. The method of claim 19, further comprising transferring, via the belt, a rotational movement to the plurality of tapered rollers, in an instance when the one or more rollers comes in contact with the plurality of tapered rollers.
